(19) United States
(12) Patent Application Publication
(10) Pub. No.: US 2003/0005620 A1
(43) Pub. Date: Jan. 9, 2003

(54) Wick based liquid emanation system

(76) Inventors: Gopal P. Ananth, Racine, WI (US); Andrea Pedrotti, Pietramurata (IT); Franco Zobele, Trento (IT); Padma P. Varanasi, Racine, WI (US)

Correspondence Address: S.C. JOHNSON & SON, INC., 1525 HOWE STREET, RACINE, WI, 53403-2236, US

(21) Appl. No.: 09/900,433

(22) Filed: Jul. 6, 2001

(51) Int. Cl. A01M 13/00; A01M 19/00

(52) U.S. Cl. 43/125

(57) ABSTRACT

A wick-based liquid emanation system, and wicks for use therewith, are disclosed. There is a liquid containing bottle having an opening for receiving a wick. The wick is partially disposed within the container and extends through an opening of the container. The wick includes an upper cavity that can collect liquid to provide an initial burst of active when the wick is first heated. The wick is preferably sheathed along a portion of its sides.

### CROSS REFERENCE TO RELATED APPLICATIONS

Not applicable

### STATEMENT REGARDING FEDERALLY SPONSORED RESEARCH/DEVELOPMENT

Not applicable

### BACKGROUND OF THE INVENTION

The present invention relates to wick-based liquid emanation systems, and more particularly to a wick-based liquid emanation systems having a wick assembly configured to provide improved control over the evaporation rate of the liquid.

A variety of wick-based liquid emanation systems are known for dispersing vaporized particles of liquids (or liquids containing) actives such as insect control agents (e.g. insect repellents; insecticides; insect growth regulators), fragrances, and deodorizers. See e.g. U.S. Pat. Nos. 4,663,315, 4,968,487, 5,095,647, 5,647,053, and 5,909,845. See also the following PCT applications: WO 97/13539, WO 97/28830, WO 98/19526, WO 98/58692, WO 99/22776, WO 00/06212, and WO 00/69479.

Typically, one end of a wick is partially submerged into a liquid to be dispersed. The liquid is contained in a bottle. A partially submerged portion of the wick absorbs the liquid, which then diffuses by capillary/wicking action up to an exposed, unsubmerged portion of the wick.

The exposed portion of the wick is locally heated, sometimes by flame (e.g. WO 99/22776), or alternatively by a ring-shaped heater which fits around the wick (e.g. U.S. Pat. No. 4,663,315). This causes the liquid to evaporate into the surrounding air. Continual application of heat to the exposed portion of the wick results in an evaporation/absorption process that continues until the liquid is consumed.

One problem associated with conventional wick-based liquid emanation systems is that the vapors to be dispersed can condense along an inside surface of an outer shell enclosing the device. This is a particular problem with long wicks, and can result in liquid dripping out of the bottom of the unit.

Another problem is a lack of precise control of the rate of dispensation of the associated insecticide, fragrance, or other liquid. Some users may want low air concentrations of the active (e.g. if a user is sensitive to a particular active). Others may want high concentrations (e.g. in highly mosquito infected areas). A related concern is the time delay between the activation of the heater and the time that an effective air concentration is reached. The heater may be turned off during the day, and then turned back on when a user arrives home. It is desirable to disperse the liquid quickly after a user first returns in order to quickly clear the room of insects and return it to a protected state (regardless of the preferences of the user regarding steady state concentration levels).

Still another concern is the loss of liquid through evaporation during storage. Yet another concern is the tendency of some of these systems to dispense vapor along portions of the wick below the top. This may lead to the coolest vapors condensing and running back into the housing or along the outsides of the container.

A still further concern relates to dispersion rates over time. With a standard wick, upon first activating the wick, the release rate tends to taper off over time. Therefore, it is difficult to select a wick which consistently disperses an appropriate amount of liquid for some applications.

One approach is to partially encase a portion of the wick that is exposed to air with an impervious outer sleeve. See e.g. U.S. Pat. Nos. 5,095,647 and 5,909,845. However, these systems slowed the rate of dispersion, thereby increasing the time between activation of the device and release of desired amounts of the volatile.

Accordingly, there is still a need for improved wick-based liquid emanation systems, and wicks for use therewith.

### SUMMARY OF THE INVENTION

In one aspect the invention provides a wick assembly for use with a wick based liquid emanation system. The wick assembly has an elongated wick having a downwardly extending, upwardly open, cavity in its upper end. There can be an outer covering layer around at least a portion of the wick.

Alternatively, the outer covering can be a metallic layer, a metallic paint, a plastic sheath or be made of other heat transferring or heat insulating materials. For the use with electric heaters, highly preferred wicks are made of a porous ceramic material.

In another aspect, the invention provides a wick-based liquid emanation system. There is a container or containing a liquid. The liquid is an active liquid selected from the group consisting of insect control agents, fragrances, and deodorizers. The container typically has an upper opening. There is a wick assembly partially disposed within the container that also has a portion extending outside the container. The wick assembly has an elongated wick with a downwardly extending, upwardly open, cavity in its upper end.

The sheath or outer covering layer prevents unwanted vaporization from the lower portion of the wick, and more uniformly disperses heat along the wick. The cavity in the wick helps provide a burst of vapor that is ready when the device is first heated. Depending on personal preferences, different wick assemblies can be substituted by the consumer for different situations.

The outer covering can be an insulating material to limit the heat distribution along the wick, thereby decreasing the rate of dispersion. Alternatively, it can be a metal which more effectively transmits heat.

Thus, the invention provides:

(a) a wick-based liquid emanation system of the above type in which the rate of dispersion can be varied;

(b) a wick-based liquid emanation system of the above type where the thermal conductivity of the wick can be varied;

(c) a wick based liquid emanation system of the above kind which reduces evaporation from the wick during storage; and

(d) wicks of the above kind which can disperse a burst of active when initially heated.

This summary of the invention has been provided so that the general nature of the invention may be understood. However, this summary should not be construed to limit the invention. Rather, the following preferred embodiments, and more importantly the claims that follow them, should be considered.

### BRIEF DESCRIPTION OF THE DRAWINGS

FIG. 1 is a frontal view of a first embodiment of the present invention;

FIG. 2 is a cross-sectional view taken along the line 2-2 of FIG. 1;

FIG. 3 is a frontal view of a second embodiment;

FIG. 4 is a cross-sectional view taken along the line 4-4 of FIG. 3;

FIG. 5 is a partial frontal view of the FIG. 3 embodiment, albeit with a slightly different wick assembly;

FIG. 6 is a partial perspective view of a third embodiment;

FIG. 7 is a cross-sectional view taken along the line 7-7 of FIG. 6;

FIG. 8 is a frontal view, partially fragmented, of a fourth embodiment; and

FIG. 9 is a cross sectional view taken along the line 9-9 of FIG. 8.

### DESCRIPTION OF THE PREFERRED EMBODIMENTS

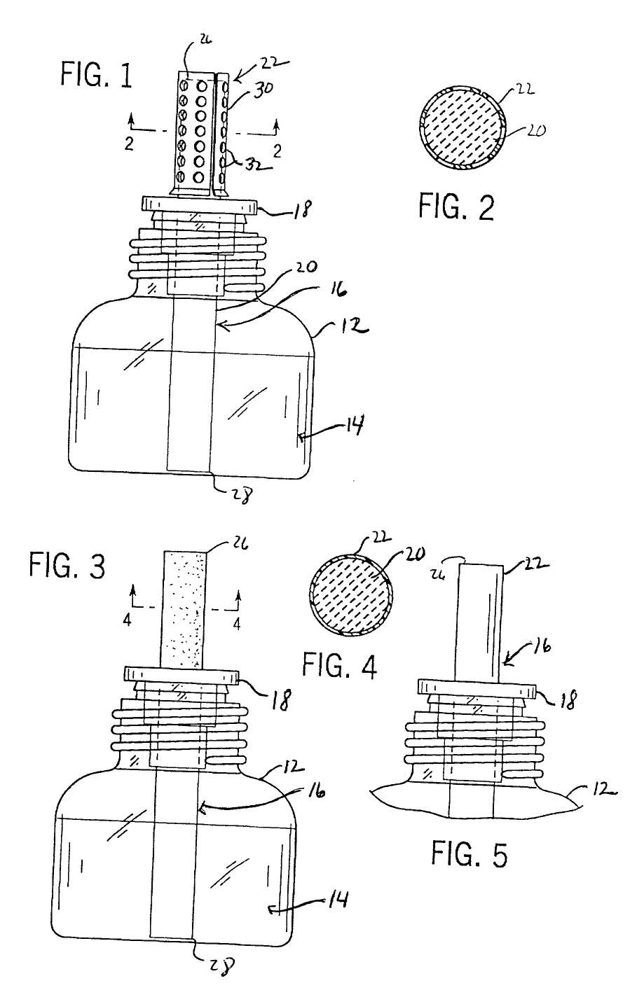

FIG. 1 illustrates a first liquid emanation system 10 including a container 12 for storing liquid 14, a wick 16 partially disposed in container 12 for dispersing the liquid 14, and a cap 18 for enclosing the container 12 and maintaining the wick 16 in an upright position. A localized heat source (not shown), preferably but not necessarily in the form of a ring-shaped heating element, encircles the wick 16. Such ring heaters are well known. See e.g. U.S. Pat. No. 4,663,315.

The liquid 14 is preferably an insecticide in a volatile solvent. However, a wide variety of active containing liquids suitable for use with the present invention are known. See e.g. U.S. Pat. No. 4,663,315.

Container 12 is preferably bottle shaped and enclosed by a cap 18 that is sized and dimensioned to be snap-fit over the neck section of the container 12. The cap 18 includes a centered aperture for receiving the wick 16, and for retaining the wick 16 in an upright position. Preferably, the wick 16 is tightly sealed in the aperture to prevent additional evaporation of the liquid 14 during storage. When the liquid 14 in the container 12 has been expended, the cap 18 and associated wick 16 can be selectively removed and placed into a replacement container 12.

The wick 16 comprises an elongated porous core section 20 which can be sleeved or sheathed in an outer covering 22, as described more fully below. The elongated porous core section 20 preferably is made of a porous ceramic material, wherein the porosity or density of the ceramic can be selected to increase the rate of dispersing. For example, to account for lower amount of overall dispersion due to an outer covering 22, a porous ceramic core 20 having a density of 0.63 gm/cm³ can be used in place of a core having a density of 0.69 gm/cm³. However, the wick can be made of other known wick materials including porous or sintered plastics, polyesters, glass-sintered fibers, sintered carbon, wood, compressed wood composites, bundled or woven natural fibers such as cotton, linen, nylon, rayon, polyester or other materials.

A first upper end 26 of the wick 16 extends out of the container 12 and into the atmosphere, the upper end 26 of the wick 16 dispensing molecularized or vaporized liquid 14 into the atmosphere. The opposing distal end 28 is received in the liquid 14 in the container, providing a means for “wicking” the liquid into the wick 16 through capillary action, where the liquid 14 is heated by the heater (not shown), vaporized and dispersed into the atmosphere. As used in the this application, the term “vaporize” includes not only gases formed by evaporation or a liquid, but also small aerosol sized particles which remain suspended during the formation of small aerosol sized particles which would remain suspended in the air for an extended period of time.

The outer covering 22 can comprise any of a number of materials that can be attached to or wrapped around the exterior surface of the core 20. Suitable materials should be selected to withstand the operating temperature of the electrical heater and to provide sufficient heat to vaporize the liquid 14, typically selected to have an activation temperature between 80 and 150° C.

The outer covering 22 can be selected to vary the thermal conductivity or heat distribution in the wick 16, and therefore to either slow or increase the heat distribution in the wick, and correspondingly the rate of release of the insecticide, fragrance, or other chemical active in the liquid 14. The outer covering 22 can also be selected to be an impervious coating. By preventing or limiting the dispersion of vapors from the wick 16 along the portion of the wick sheathed in the outer coating 22, the overall rate of dispersion would be decreased absent the cavity of the present invention. Particularly suitable materials for the outer coating include plastics, paints, or various types of solid sleeving including aluminum and aluminum alloys, copper and copper alloys of high density/temperatures polyethylenes, polypropylenes, polyesters, polyester terephthalates, and polyalkene terephthalates such s multilayer polymer films.

Referring still to FIG. 1 and also to FIG. 2, a first embodiment of an outer covering 22 comprises a sleeve 30, extending substantially from the aperture defined in the cap 18 to the first upper end 26 of the wick 16. The sleeve 30 is preferably constructed from a metal or metallic material, which provides a uniform heat distribution over the wick 16, thereby increasing the speed of the heat-activated chemical reaction in the liquid 14.

A plurality of perforations 32 can be provided in the sleeve 30, the perforations 32 allowing for volatile to be released along the length of the wick 16. Although a metallic sleeve 30 comprising a plurality of perforations 32 has been shown and described, sleeves 30 comprised of solid metal foil, of a metal lattice or grid, or of other materials selected to vary the difference of heat along the wick and/or to limit dispersion of the volatile can also be used. Furthermore, although the sleeve 30 has been shown extending from the top of the cap 18 to the distal end 26 of the wick, the sleeve 30 can extend the full length of the wick 16, along the upper half of the wick 16, or extend along only a portion of the wick 16.

Referring next to FIGS. 3, 4, and 5, a second embodiment of an outer covering is shown. Here, the outer covering 22 of the wick 16 comprises a metalized plastic material. As with the metallic sleeve 30 described above, an outer covering 22 comprising a metalized plastic material can aid in providing a uniform heat distribution around the wick, and therefore increasing the speed of the reaction of the volatile in the liquid 14. As shown in FIG. 5, the metalized plastic material can extend along the entire length of the wick 16. Alternatively, as shown in FIG. 3, the metalized material can extend only above the cap 18.

In some applications, different materials can be employed in the upper (above the cap 18) and lower (below the cap 18) portions of the wick 16. Furthermore, perforations such as those described in connection with FIG. 1 can also be used with the plastic covering.

Although a metalized film has been described, it will be apparent to those of ordinary skill in the art that other types of plastic coating materials can also be used. For example, plastic insulative materials which tend to slow the distribution of heat along the wick 16 can be employed to slow the reaction of the volatile in the liquid 14, and therefore to reduce the rate of dispersion of the liquid 14. Furthermore, plastic materials which limit dispersion of the volatile are also useful. Insulative or impervious plastic materials can be desirable, for example, to users who are sensitive to the dispensed volatiles, and in other situations in which only a small amount of volatile is required.

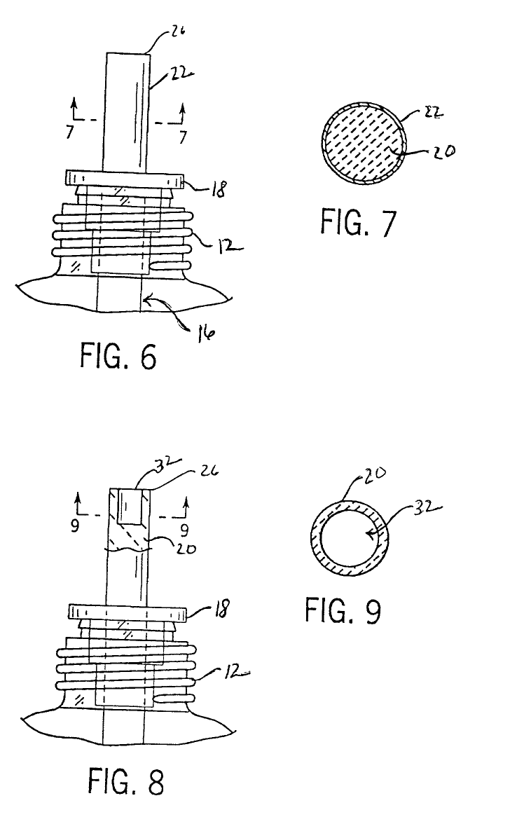

Referring next to FIGS. 6 and 7, a third embodiment is shown wherein the outer covering 22 comprises a paint. Again, the paint can comprise a heat conductive material, such as a metalized paint, to increase the dispersion of chemicals into the atmosphere. Alternatively, the paint can comprise an insulative material for slowing the rate of the reaction, thereby decreasing the rate of dispersion. As noted above, the outer coating can also be selected to limit or prevent dispersion of volatile along the portion of the wick 16 enclosed in the outer covering 22. As described above, an outer covering 22 comprising paint can be extended along the entire length of the wick 16, or along a portion of the wick 16, and can also include perforations or vents. Furthermore, the paint can be extended only up to the distal end 26, or can be extended over the end portion of the wick 16.

Referring now to FIGS. 8 and 9, a cutaway view of a wick 16 of the present invention is shown. A cavity 32 is provided in the upper end 26 of the elongated porous core section 20 of the wick 16, extending axially in a generally downward direction in the core section 20. The cavity 32 (and the walls adjacent thereto) collect liquid 14 from the container 12 through the wick 16 by means of capillary action, forming a pool of liquid 14 in the cavity 32. The cavity can be rectangular in shape, as shown, comprise a curved concave section, or configured in any number of other shapes. Preferably, the cavity 32 is sized and dimensioned to retain a predetermined amount of liquid 14, capable of being quickly dispersed upon activation. The wick 16, although shown without an outer covering 22, is preferably covered with a metal sleeve 32, plastic film, or paint as described above.

In operation, liquid 14 is drawn into the porous core section 20 of a wick 16 through capillary or “wicking” action. The wick 16 is heated with the heater (not shown) to a predetermined temperature at which a volatile in the liquid 14 disperses.

In the cavity 32 defined in the distal end 26 of the wick 16, a pool of liquid 14 can be formed when the heater is in an “off” position. When heat is applied to the wick 16, the pool of liquid 14 can be dispersed rapidly, thereby providing a “burst” of volatile, useful for example when an insecticide is required to clear a room quickly after the wick-based liquid emanation system has been turned “off” for an extended period of time. The cavity 32 is also advantageous when the wick 16 includes an outer covering 22 which impedes dispersion of the volatile. In this application, the pool of liquid 14 in the cavity 32 can be used to increase the rate of dispersion.

As noted above, the wick 16 is selectively snap-fit into the container 12. Consequently, after the wick-based liquid emanation system 10 is in use, a user can evaluate the rate of dispersion from the container 12, and selectively choose to replace the wick 16 with a wick 16 having a higher or lower rate of dispersion, as desired.

In a highly preferred embodiment of the invention, the porous core 20 comprises a ceramic having a density of 0.63 grams/cm³, and includes a cavity 32 in the distal end 26. The core 20 can be sheathed in any of the outer coverings 22 described above to provide various ranges of dispersion. A wick 16 constructed in this way has been shown experimentally to maintain a fairly constant rate of dispersion over time.

A method of emanating a volatile liquid is also disclosed comprising the steps of first providing the wick-based liquid emanation system disclosed above whose container contains the liquid to be emanated, together with a heater suitable for heating a portion of the wick extending outside of the container, and, second, activating the heater.

Although specific embodiments of the present invention have been described in detail above, it should be understood that this description is merely for purposes of illustration. Various modifications of and equivalent structures corresponding to the disclosed aspects of the preferred embodiments are meant to be within the scope of the claims. Accordingly, the scope of the invention defined by the following claims should be accorded the broadest reasonable interpretation so as to encompass such modifications and equivalent structures.

### Industrial Applicability

The invention provides improved dispensers for dispensing volatile actives of interest.

We claim:

1. A wick assembly for use with a wick based liquid emanation system for use with a heater having a heated area, the liquid emanation system including a container for holding the liquid to be emanated, the wick assembly comprising a wick to be partially disposed within the container when used therewith, the wick being designed to extend from the liquid to outside the container and through the heated area, the sides of the portion of the wick extending through the heated area having an outer covering layer that extends from within the heated area toward the end of the wick remote from the container.

2. The wick assembly of claim 1 wherein the wick has a downwardly extending, upwardly open, cavity in its end remote from the container.

3. The wick assembly of claim 1, wherein the outer covering is metallic.

4. The wick assembly of claim 1, wherein the outer covering comprises a paint.

5. The wick assembly of claim 1, wherein the outer covering comprises a plastic sheath.

6. The wick assembly of claim 1, wherein the wick is made of a porous ceramic material.

7. A wick-based liquid emanation system, comprising:
a container containing a liquid, said container having an opening, and said liquid being an active liquid selected from the group consisting of insect control agents, fragrances, and deodorizers; and
a wick assembly partially disposed within said container and having a portion extending outside the container, the wick assembly comprising an elongated wick having a downwardly extending, upwardly open, cavity in its upper end.

8. A wick-based liquid emanation system for use with a heater having a heated area, the liquid emanation system comprising:
a container containing a liquid, said container having an opening, and said liquid including an active liquid selected from the group consisting of insect control agents, fragrances, and deodorizers; and
a wick assembly partially disposed within said container and having a portion extending outside the container and through the heated area, the sides of the portion extending outside the container having an outer covering layer that extends from within the heated area toward the end of the wick assembly remote from the container.

9. The wick-based liquid emanation system of claim 8 wherein the outer covering is metallic.

10. The wick-based liquid emanation system of claim 8 wherein the outer covering comprises a paint.

11. The wick-based liquid emanation system of claim 8 wherein the outer covering comprises a plastic sheath.

12. The wick-based liquid emanation system of claim 8 wherein the wick has a downwardly extending, upwardly open, cavity in its end remote from the container.

13. A method of emanating a volatile liquid comprising the steps of
a. providing the wick-based liquid emanation system of claim 8 whose container contains the liquid to be emanated and a heater suitable for heating a portion of the wick extending outside of the container, and
b. activating the heater.
